(19) United States
(12) Patent Application Publication
(10) Pub. No.: US 2005/0116468 A1
(43) Pub. Date: Jun. 2, 2005

(54) Threaded connectors for axial alignment of tubular components, and method of installing pipe sections employing such connectors

(76) Inventor: Gregory K. Otten, Houston, UT (US)

Correspondence Address: JEFFREY E. DALY;GRANT PRIDECO, L.P., 400 N. SAM HOUSTON PARKWAY EAST, SUITE 900, HOUSTON, TX, 77060, US

(21) Appl. No.: 10/707,228

(22) Filed: Nov. 28, 2003

(51) Int. Cl. F16L 55/00

(52) U.S. Cl. 285/90; 285/148.12; 285/148.7; 285/333; 285/390

(57) ABSTRACT

The present invention is directed to threaded connectors for axial alignment of tubular components, and methods of installing pipe sections employing such connectors. In one illustrative embodiment, the method comprises a first section of pipe comprised of at least one length of pipe, a threaded pin connector coupled to the first section of pipe, a second section of pipe comprised of at least one length of pipe and a threaded box connector coupled to the second section of pipe, the box and pin connectors being threadingly coupled to one another and welded to one another along an exterior grooved circumferential weld joint.

### BACKGROUND OF INVENTION

1. Field of the Invention

The present invention is generally related to the field of threaded connectors and to the laying of pipelines, and, more particularly, to threaded connectors for axial alignment of tubular components, and methods of installing pipe sections employing such connectors.

2. Description of the Related Art

Pipelines or transmission lines are created in a variety of industries to allow the flow of a liquid or gas therethrough. For example, it is very common to position pipelines on the ocean floor to thereby allow the flow of hydrocarbons, e.g., oil and gas, as well as other fluids therethrough. Construction of such pipelines is a very time-consuming and expensive undertaking. The construction process typically involves butt-welding lengths or segments of pipe to one another to create the pipeline or transmission line. The pipelines or transmission lines can be laid on the floor of an ocean or above the surface of the earth, i.e., surface pipelines.

With respect to the formation of subsea pipelines, there are a variety of known techniques for forming such pipelines. Such processes typically involve the use of an oceangoing lay-vessel and welding sections of pipe together on board the vessel to thereby create the pipeline. Illustrative techniques for forming such pipelines include so-called “J-lay” techniques wherein the pipeline leaves the lay-vessel in an inclined or even near vertical orientation in order to allow the laying of the pipeline in deep water without stressing the pipeline material excessively. Illustrative examples of the J-lay technique are disclosed in, for example, U.S. Pat. Nos. 6,352,388 B1 and 5,464,307, both of which are hereby incorporated by reference in their entirety. Another known technique is the so-called “S-lay” technique wherein the pipeline leaves the lay-vessel in a substantially horizontal orientation, bends downward over a supporting structure, the so-called stinger, and when approaching the sea bottom bends upward to be laid on the sea bottom. One illustrative description of an S-lay technique is disclosed in U.S. Pat. No. 3,715,890, which is hereby incorporated by reference in its entirety.

FIGS. 1A-1C will now be employed to further discuss an illustrative J-lay technique for laying a pipeline on a seabed. However, it should be understood that the present invention is not limited to use with J-lay techniques or to the formation of subsea pipelines or transmission lines. As depicted in FIG. 1A, a lay-vessel 10 is used to position a pipeline 12 on the floor 15 of the ocean 14. At the point in time depicted in FIG. 1A, previous sections of the pipeline 12 have already been formed, and an upper end 12e of the pipeline 12 is positioned above the surface 10a of the lay-vessel 10 such that a new pipe section 18 may be welded to the existing pipeline 12. The pipeline 12 typically extends through a moon pool 10b formed in the lay-vessel 10.

A plurality of pipe sections 18 are positioned in a lay-down area 16 on the lay-vessel 10. In some embodiments, a separate support vessel may be provided alongside the lay-vessel 10 to provide the necessary storage for the pipe sections 18. Typically, each of the pipe sections 18 will be comprised of multiple pipe lengths. In the depicted embodiment, the pipe sections 18 are comprised of four pipe lengths 18a, 18b, 18c, 18d, wherein adjacent pipe lengths are butt-welded to one another at weld seams 19. Typically, the pipe sections 18 are assembled on-shore and then loaded onto the lay-vessel 10 such that they may later be assembled to form the pipeline 12. The number of individual pipe lengths that make up a pipe section 18 may vary. In the depicted embodiment, four individual pipe lengths, 18a, 18d, make up the pipe section, i.e., a so-called “quadruple” or “quad” arrangement, having a length of approximately 160 feet. Other configurations are also possible, e.g., pipe sections comprised of three pipe lengths (“triples”) or two pipe lengths (“doubles”). Such pipe sections 18 are sometimes generically referred to as “pipe stalks.” As indicated in FIG. 1A, joining of a pipe section 18 to the existing pipeline 12 using a J-lay technique involves positioning the pipe section 18 in a near vertical position, e.g., positioning the pipe section 18 at an angle 21 (see FIG. 1B) of approximately 5-10 degrees relative to a plane perpendicular to the surface 10a of the lay-vessel 10, using a pipe section alignment tower 17. In some techniques, the pipe section 18 to be attached to the end 12e of the pipeline 12 is positioned in the pipe section alignment tower 17 while the tower 17 is in an approximately horizontal position. Thereafter, the tower 17 is raised such that the pipe section 18 is in a near vertical orientation. Ultimately, as depicted in FIG. 1C, the end 18e of the pipe section 18 will be butt-welded to the end 12e of the pipeline 12. A variety of holding and positioning mechanisms may be coupled to the pipe section alignment tower 17 to allow handling and positioning of the pipe section 18 at a desired location. For example, such mechanisms may include fixed or moveable clamping mechanisms to secure the pipe during welding operations and/or during the process of lowering the pipeline 12 into the ocean. As another example, a gimbal control mechanism can be employed to move the pipe section 18 in multiple directions. Illustrative clamping and/or positioning mechanisms 23a-23c as well as an illustrative gimbal control mechanism 27 are schematically depicted in FIG. 1A.

A typical assembly process for joining the pipe section 18 to the pre-existing pipeline 12 will now be further described with reference to FIGS. 1B and 1C. As indicated in FIG. 1C, the ultimate objective is to butt-weld the end 12e of the pipeline 12 to the end 18e of the pipe section 18, thereby producing the weld joint 20. As explained more fully below, this is typically accomplished by performing multiple welding passes to completely fill the weld joint 20. As indicated in FIG. 1B, a schematically depicted orbital welding device 28 is used to weld the pipe section 18 to the pipeline 12 at weld joint 20. The orbital welding device 28 may circumscribe the joint 20 by traveling on the illustrative structure 30 depicted therein.

However, prior to completing the weld joint 20, a great deal of activities are undertaken to properly align the end 18e of the pipe section 18 relative to the end 12e of the pipeline 12. The position of the pipeline 12 relative to the surface 10a of the lay-vessel 10 is maintained via the use of a plurality of powered pipe slips 26 that clamp and secure the pipeline 12 in the desired location. Thereafter, the pipe section 18 that is to be attached to the pipeline 12 is coarsely positioned relative to the end 12e of the pipeline 12 through use of the pipe section alignment tower 17 and the gimbal mechanism 27. Additionally, aligning the pipe section 18 to the pipeline 12 may involve use of a hydraulically-actuated alignment device 22 that is positioned on the interior of the weld joint 20 prior to performing welding operations. Hydraulic power is supplied to the alignment device 22 via hydraulic supply line 24. In general, the alignment device 22 will be used to circumferentially align the end 18e of the pipe section 18 with the end 12e of the pipeline 12 prior to beginning welding operations.

After proper alignment is achieved, a root pass may be made on the weld joint 20 followed by the removal of the alignment device 22. Thereafter, several filling passes may be made with the orbital welding device 28 to complete the weld joint 20. Using this existing methodology, the weld joint 20 has a thickness that corresponds to the thickness of the pipe lengths used to make the pipeline 12. Thereafter, the weld joint 20 is allowed to cool and various non-destructive examination (NDE) techniques, e.g., x-ray, may be employed to examine the quality of the resulting weld joint 20. Then, the pipe slips 26 are released and the newly added pipe section 18 is lowered into the ocean 14. This process is repeated many times to complete the formation of the pipeline 12.

The above-mentioned process can be very time-consuming and costly. For example, for an illustrative 30-inch diameter pipeline 12, the various alignment and welding techniques described above may take up to 1-1.5 hours per weld joint 20. What is desired are products and methodologies that enable the formation of pipeline in a more rapid and cost-effective manner.

The present invention is directed to an apparatus and methods for solving, or at least reducing the effects of, some or all of the aforementioned problems.

### SUMMARY OF INVENTION

The present invention is directed to threaded connectors for axial alignment of tubular components, and methods of installing pipe sections employing such connectors. In one illustrative embodiment, the device comprises a first section of pipe comprised of at least one length of pipe, a threaded pin connector coupled to the first section of pipe, a second section of pipe comprised of at least one length of pipe and a threaded box connector coupled to the second section of pipe, the box and pin connectors being threadingly coupled to one another and welded to one another along an exterior grooved circumferential weld joint.

In another illustrative embodiment, the device comprises a first section of pipe comprised of a plurality of lengths of pipe wherein adjacent lengths of pipe are butt-welded to one another, a threaded pin connector coupled to the first section of pipe, a second section of pipe comprised of a plurality of lengths of pipe wherein adjacent lengths of pipe are butt-welded to one another, and a threaded box connector coupled to the second section of pipe, the box and pin connectors being threadingly coupled to one another and welded to one another along an exterior grooved circumferential weld joint, wherein a sealing interface exists between an exterior sealing surface of the pin connector and an interior sealing surface of the box connector.

In yet another illustrative embodiment, the device comprises a first section of pipe comprised of at least one length of pipe, a threaded box connector coupled to a first end of the first section of pipe and a threaded pin connector coupled to a second end of the first section of pipe, wherein an end surface on the pin connector is adapted to define a portion of an external grooved circumferential weld joint between the pin connector and a mating box connector on a second section of pipe comprised of at least one length of pipe when the pin connector and the mating box connector on the second section of pipe are threadingly coupled to one another.

In a further illustrative embodiment, the device comprises a first section of pipe comprised of a plurality of lengths of pipe wherein adjacent lengths of pipe are butt-welded to one another, a threaded box connector coupled to a first end of the first section of pipe and a threaded pin connector coupled to a second end of the first section of pipe, the threaded pin connector having an exterior sealing surface and an end surface on the pin connector that is adapted to define a portion of an external grooved circumferential weld joint between the pin connector and a mating box connector on a second section of pipe comprised of at least one length of pipe when the pin connector and the mating box connector on the second section of pipe are threadingly coupled to one another, the mating box connector further comprising an internal sealing surface that is adapted to sealingly engage the exterior sealing surface on the pin connector when the pin connector and the mating box connector are threadingly coupled to one another.

In one illustrative embodiment, the method comprises forming a pipeline, an end of the pipeline having a threaded connector, providing a pipe section comprised of at least one length of pipe, the pipe section having threaded connectors on each end of the pipe section, threadingly coupling one of the threaded connectors on the pipe section to the threaded connector on the end of the pipeline and welding the threaded connector on the pipe section to the threaded connector on the end of the previously formed pipeline along an exterior circumferential weld joint. In further embodiments, the step of threadingly coupling one of the connectors on the pipe section to the threaded connector on the end of the pipeline establishes a sealing interface by providing an interference fit between a sealing surface on the connector on the pipe section and a sealing surface on the connector on the end of the pipeline.

### BRIEF DESCRIPTION OF DRAWINGS

The invention may be understood by reference to the following description taken in conjunction with the accompanying drawings, in which like reference numerals identify like elements.

FIGS. 1A-1C depict illustrative examples of a prior art J-lay technique for forming undersea pipelines.

FIG. 2 is an illustrative pipe section having threaded connectors in accordance with one illustrative embodiment of the present invention formed thereon.

FIG. 3 is a depiction of a mated connector in accordance with one illustrative embodiment of the present invention.

FIGS. 4A-4D are enlarged views of one illustrative embodiment of a threaded connector in accordance with the present invention.

FIGS. 5A and 5B depict installation of an illustrative pipeline in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers” specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In general, the present invention is directed to threaded connectors for axial alignment of tubular components, and methods of installing pipe sections employing such connectors. As will be recognized by those skilled in the art after a complete reading of the present application, the present invention may be employed for a variety of techniques and purposes. In one particular example, the present invention may be employed in the context of forming sub-surface and surface pipelines and transmission lines. Even more specifically, any of a variety of known techniques for forming pipelines may be employed with the present invention, e.g., J-lay techniques, S-lay techniques, etc. Thus, the present invention should not be considered as limited to the formation of surface or sub-surface pipelines, or to any particular technique for forming pipelines, unless such limitations are expressly set forth in the appended claims.

FIG. 2 is a depiction of an illustrative pipe section 50 in accordance with one illustrative embodiment of the present invention. As indicated therein, the pipe section 50 is comprised of four individual pipe lengths 52a, 52b, 52c and 52d and a pin connector (male connector) 54p and a box connector (female connector) 54b. In the depicted embodiment, the individual pipe lengths 52a-52d are coupled to adjacent pipe lengths via butt-welds 56. Similarly, the pin connector 54p and box connector 54b are coupled to adjacent pipe lengths via butt-welds 56. The pin connector 54p and box connector 54b are adapted to be threadingly coupled to a box connector and pin connector, respectively, that may be positioned on another pipe section 50.

In general, the pipe section 50 may be assembled in a land-based factory prior to the being transported to the pipeline installation site. It should be understood that the pipe section 50 depicted in FIG. 2 is illustrative in nature as it relates to the number of individual pipe lengths 52 that comprise the pipe section 50. In the depicted embodiment, there are four illustrative pipe lengths 52a-52d (a so-called “quad” arrangement). However, the present invention may be employed in cases where a different number of pipe lengths are used to make up the pipe section 50. For example, the present invention may be employed where only a single pipe length is used, i.e., the pin connector 54p and box connector 54b are coupled to a single length of pipe (having an illustrative length of approximately 40 feet), or where two or three lengths of pipe are coupled together (so-called doubles or triples, respectively) to make up the pipe section 50. Thus, the present invention should not be considered as limited to use with any particular number of pipe lengths that make up the pipe section 50 unless such limitations are expressly set forth in the appended claims.

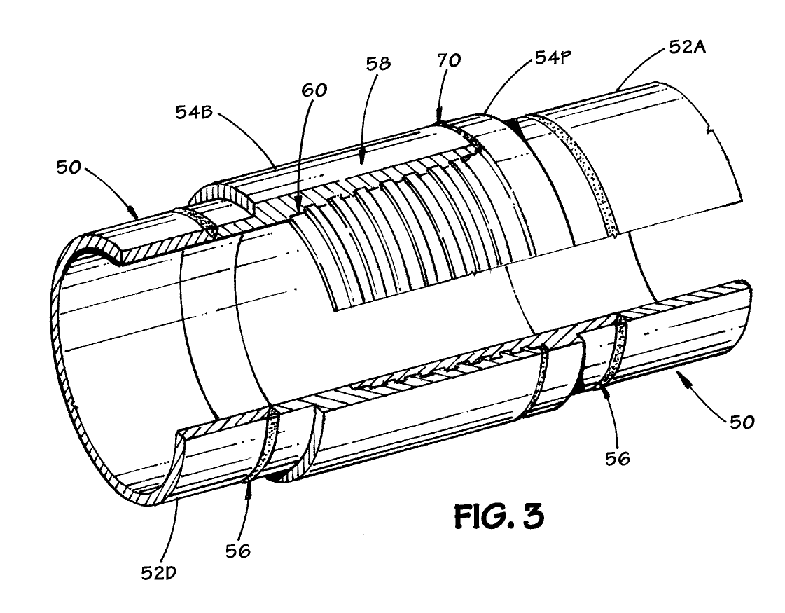

FIG. 3 is a partial, cross-sectional perspective view of a mated pin connector 54p and box connector 54b, which of which are coupled to respective pipe sections 50. As shown therein, the pin connector 54p and box connector 54b are threadingly engaged to one another by a plurality of threads 58. Additionally, in one illustrative embodiment, a sealing interface 60 (described more fully below) is provided between the pin connector 54p and the box connector 54b. The pin connector 54p and box connector 54b are also welded together at weld joint 70. In general, the weld joint 70 is a circumferential weld that extends around the entire circumference of the mated connectors. However, in some cases, the weld may not extend around the entire circumference of the mated connectors.

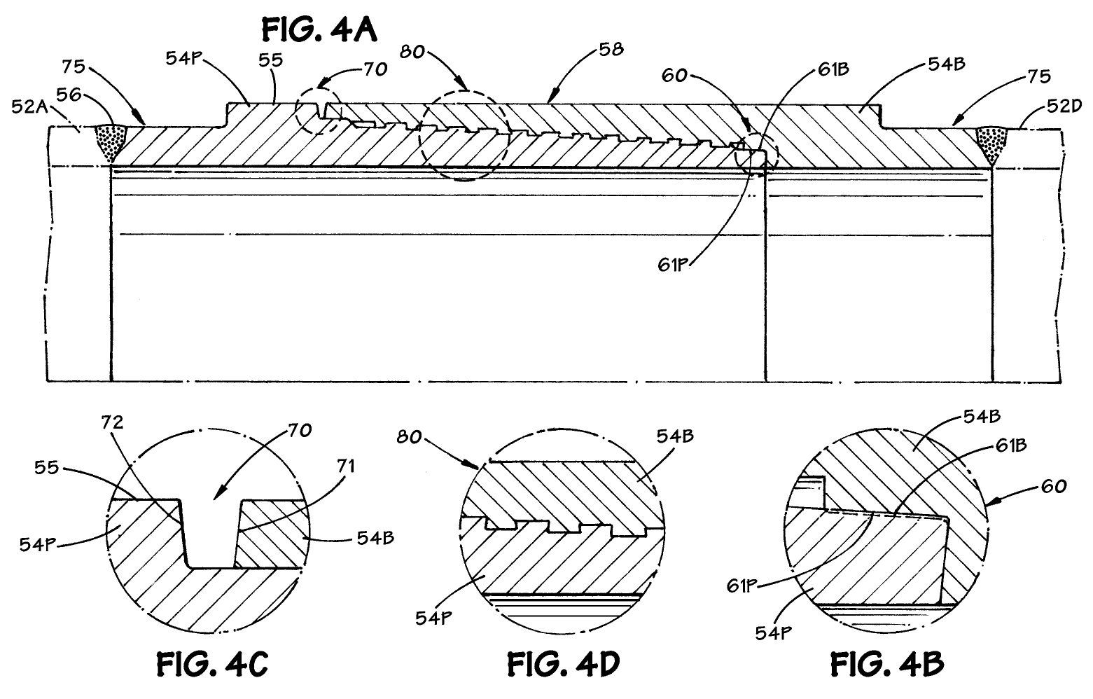

FIGS. 4A-4D depict enlarged, cross-sectional views of a mated pin connector 54p and box connector 54b. As indicated therein, the sealing interface 60 is established between an exterior sealing surface 61p on the pin connector 54p and an interior sealing surface 61b on the box connector 54b. Typically, the sealing interface 60 is established by providing an interference fit between the surfaces 61p and 61b. The sealing interface 60 provides a liquid-tight and gas-tight seal for fluids flowing through the pipeline.

The threaded connection 58 between the pin connector 54p and the box connector 54b may be comprised of a variety of different thread configurations 80. In one illustrative embodiment, the threaded connection 58 is comprised of wedge-shaped, dovetailed thread forms 80 with a continuously varying flank-to-flank width. The illustrative wedge-shaped threads are provided to ensure that as the connectors 54p and 54b are being mated together, the joint becomes tighter and tighter as the connection is made.

When the connectors 54p and 54b are mated together, a grooved weld joint 70 is created between the pin connector 54p and the box connector 54b. More specifically, a grooved weld joint 70 is defined between an end surface 71 of the box connector 54b and a surface 72 of the pin connector 54p. In one particular embodiment, the surface 72 is a side surface formed on a shoulder 55 of the pin connector 54p. In the illustrative example depicted in FIGS. 4A-4D, the diameter of the outer surface of the shoulder 55 is approximately the same as the diameter of the outer surface of the box connector 54b at the weld joint 70. In the depicted embodiment, the weld joint 70 is a low profile J-bevel weld joint 70. However, the configuration of the weld joint 70 may be varied if desired. For example, the weld joint 70 may be a single- or double-beveled grooved weld joint 70. The illustrative grooved weld joint 70 provides additional strength between the connectors 54p, 54b relative to other types of weld joints, e.g., a fillet weld joint. Filling of the weld joint 70 provides mechanical connection between the box connector 54b and the pin connector 54p and provides a redundant, or secondary, seal with respect to the fluids flowing within the pipeline 12. In one illustrative embodiment of the present invention, the weld joint 70 may be filled by performing a single submerged arc welding process.

Additionally, due to the configuration of the connectors 54p, 54b, attachment areas 75 (see FIG. 4A) are provided on the connectors 54p, 54b. Such attachment areas 75 may be used for a variety of purposes during handling of the pipe section 50 and/or during the assembly of the pipeline 12. For example, various lifting ropes or chains may be attached to the pipe section 50 at one of the attachment areas 75. The size and configuration of the attachment areas 75 may vary. In one illustrative embodiment, each of the attachment areas 75 has an axial length of approximately 3 inches and a radial depth of approximately 0.625 inches.

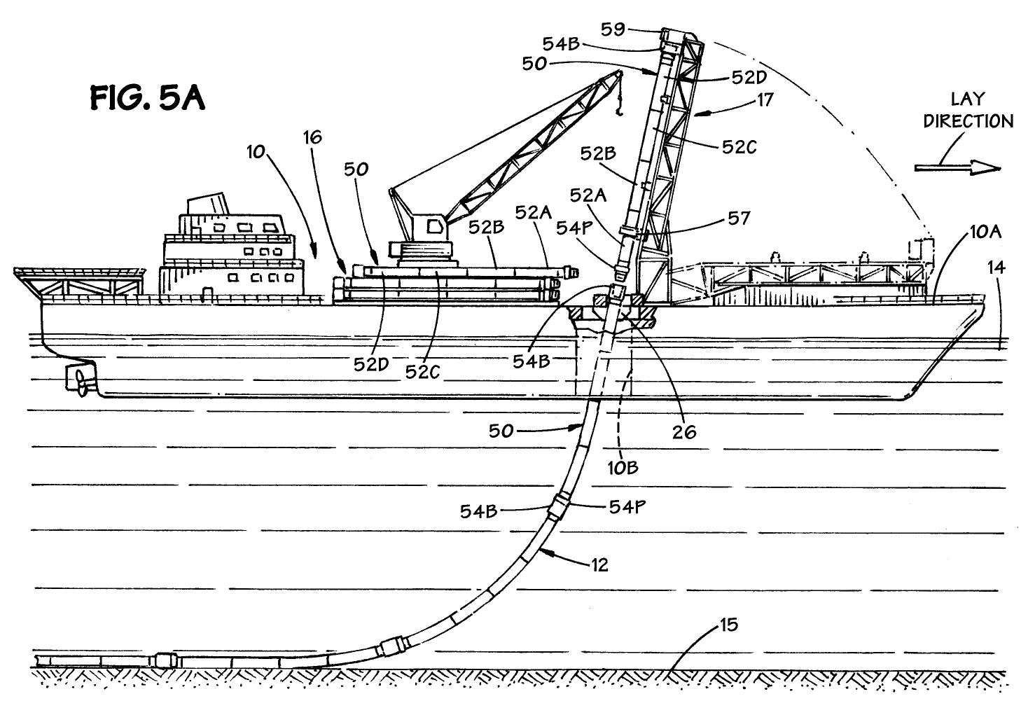

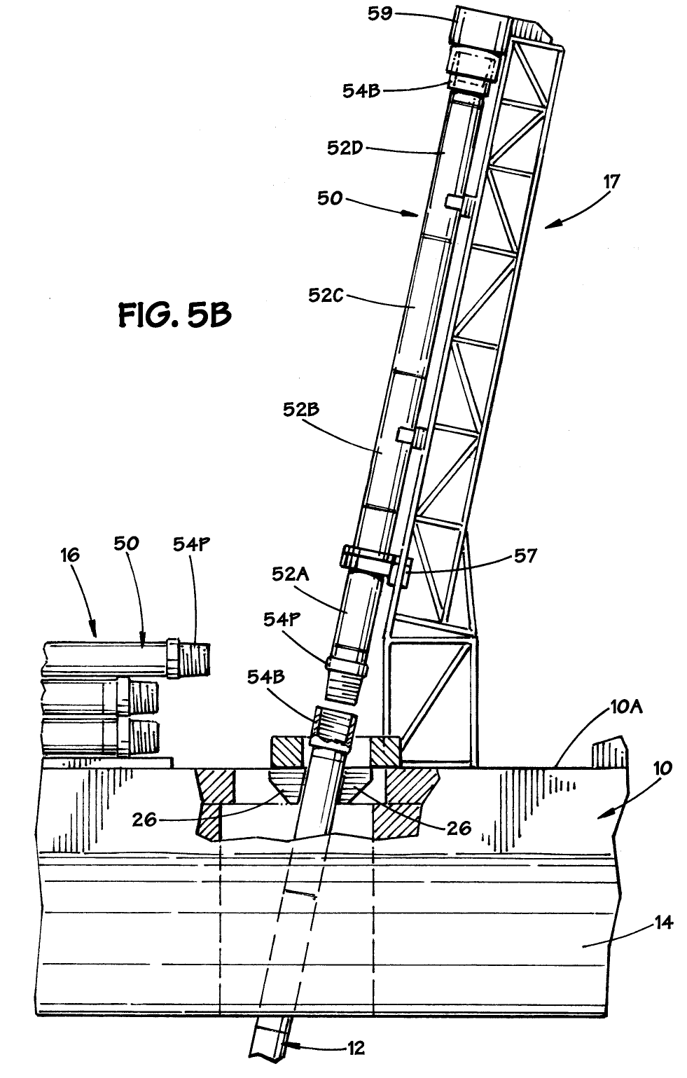

Use of the present invention in the context of forming a subsea pipeline using a J-lay technique will now be described with reference to FIGS. 5A and 5B. However, as indicated previously, the present invention should not be considered as limited to such an application, unless such limitations are expressly set forth in the appended claims. For example, the present invention may also be employed in connection with forming a land-based or surface pipeline. As depicted in FIG. 5A, a plurality of pipe sections 50 comprised of the pin and box connectors 54p, 54b are positioned on the lay-vessel 10. The previously formed pipeline 12 has an end with a threaded connector, e.g., a box connector 54b or a pin connector 54p, positioned thereon. In the illustrative embodiment depicted in FIG. 5A, an illustrative box connector 54b is depicted on the end of the pipeline 12. In this illustrative example, the box connector 54b on the previously installed pipeline 12 is positioned above the surface 10a of the lay-vessel 10 and secured in position by the pipe slips 26. An illustrative pipe section 50 in accordance with the present invention is positioned in the pipe section alignment tower 17. The pipe section 50 is depicted in the position where the pin connector 54p of the pipe section 50 may now be mated with the box connector 54b of the previously formed pipeline 12. Of course, the situation could be reversed if desired, i.e., the end of pipeline 12 could have a pin connector 54p and the box connector 54b of pipe section 50 could be threadingly coupled to the pin connector 54p on the previously formed pipeline 12. As with the prior art technique, the pipe section alignment tower 17, various positioning and clamping mechanisms, as well as a gimbal positioning mechanism, may be employed to coarsely position the pipe section 50 prior to threadingly engaging the pin 54p of the pipe section 50 with the box 54b of the pre-existing pipeline 12.

The lay-vessel 10 also includes a means for rotating the pipe section 50 to thereby threadingly engage the pin connector 54p with the box connector 54b. Any of a variety of known techniques and structures may be employed for rotating the pipe section 50. For example, a schematically depicted power tong 57, such as that described in U.S. Pat. No. 6,330,911 B1, may be provided to provide the desired rotational movement to the pipe section 50. U.S. Pat. No. 6,330,911 B1 is hereby incorporated by reference in its entirety. Alternatively, a schematically depicted top drive unit 59 may be employed to provide the desired rotational movement to the pipe section 50. One illustrative embodiment of such a top drive mechanism 59 that may be employed is disclosed in U.S. Pat. No. 6,622,796 B1, which is hereby incorporated by reference in its entirety. Of course, slight modifications may be necessary to devices depicted in the above-described patents for use with the present invention. However, such modifications are well within the level of skill in the art.

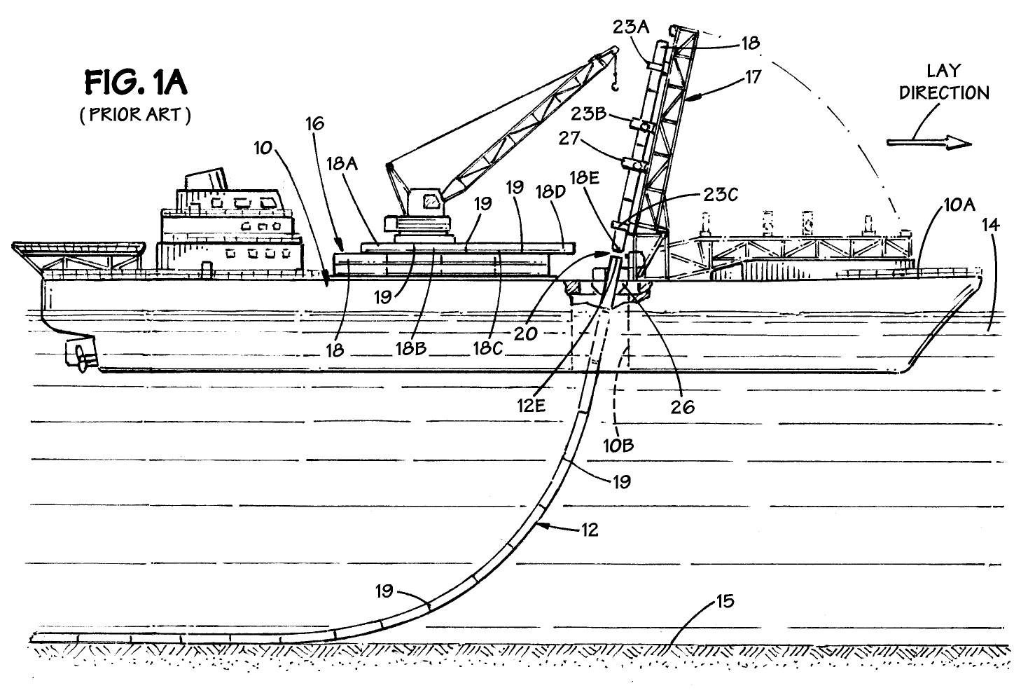

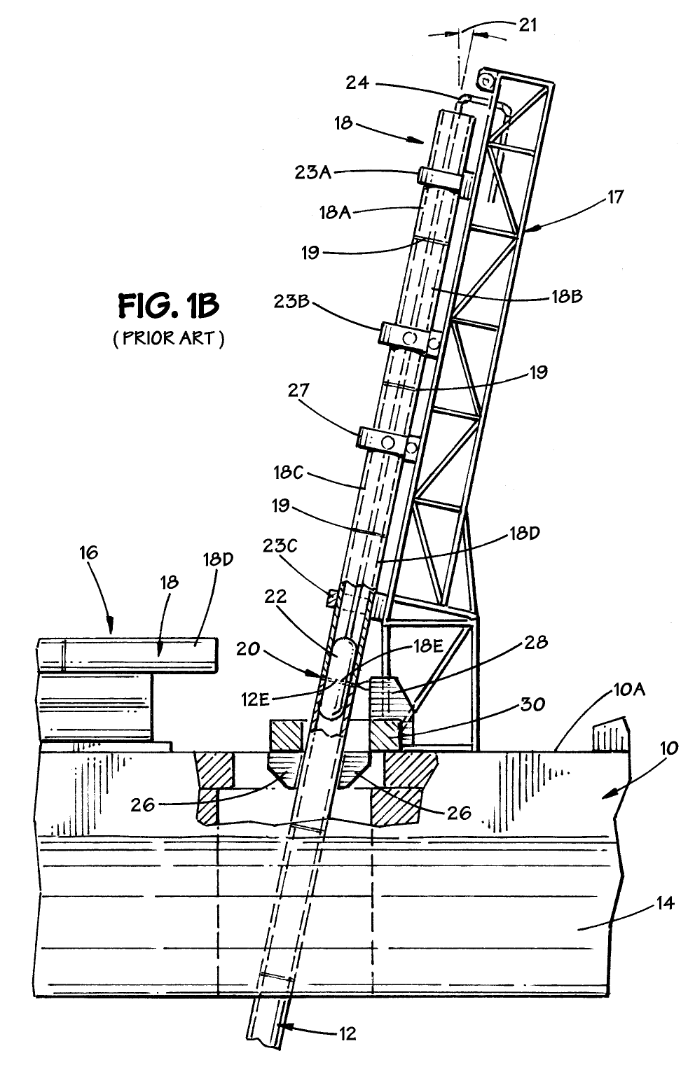

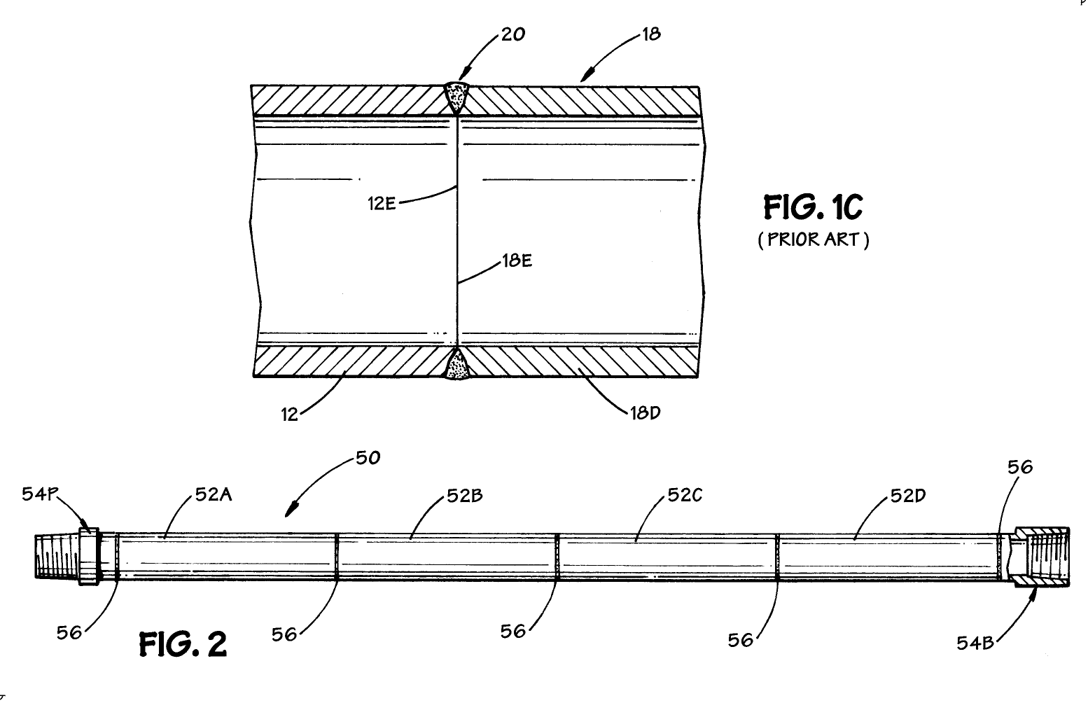

The structures and methodologies described herein provide many advantages relative to the prior art. For example, in employing the present invention, the alignment device 22 depicted in FIG. 1B is not required. Additionally, in one illustrative embodiment, the weld joint 70 of the present invention has a depth that is typically approximately 20-30%, and in a more specific embodiment, approximately 25%, of the wall thickness of the pipe lengths used to make up the pipe section 50. As a result, the welding process used to fill the weld joint 70 may be performed much more quickly when compared to the prior art technique wherein individual pipe lengths or sections are butt-welded to one another. For example, in the case of an illustrative 30-inch diameter pipeline, butt-welding the individual pipe lengths or sections to one another in accordance with the prior art techniques disclosed above typically required approximately 1-1.5 hours; whereas, filling the weld joint 70 in accordance with the present invention may be performed in approximately 15-20 minutes. Obviously, such time savings greatly increase productivity and reduce costs as it relates to creating and laying the pipeline 12.

The present invention is directed to threaded connectors for axial alignment of tubular components, and methods of installing pipe sections employing such connectors. In one illustrative embodiment, the device comprises a first section of pipe comprised of at least one length of pipe, a threaded pin connector coupled to the first section of pipe, a second section of pipe comprised of at least one length of pipe and a threaded box connector coupled to the second section of pipe, the box and pin connectors being threadingly coupled to one another and welded to one another along an exterior grooved circumferential weld joint.

In another illustrative embodiment, the device comprises a first section of pipe comprised of a plurality of lengths of pipe wherein adjacent lengths of pipe are butt-welded to one another, a threaded pin connector coupled to the first section of pipe, a second section of pipe comprised of a plurality of lengths of pipe wherein adjacent lengths of pipe are butt-welded to one another, and a threaded box connector coupled to the second section of pipe, the box and pin connectors being threadingly coupled to one another and welded to one another along an exterior grooved circumferential weld joint, wherein a sealing interface exists between an exterior sealing surface of the pin connector and an interior sealing surface of the box connector.

In yet another illustrative embodiment, the device comprises a first section of pipe comprised of at least one length of pipe, a threaded box connector coupled to a first end of the first section of pipe and a threaded pin connector coupled to a second end of the first section of pipe, wherein an end surface on the pin connector is adapted to define a portion of an external grooved circumferential weld joint between the pin connector and a mating box connector on a second section of pipe comprised of at least one length of pipe when the pin connector and the mating box connector on the second section of pipe are threadingly coupled to one another.

In a further illustrative embodiment, the device comprises a first section of pipe comprised of a plurality of lengths of pipe wherein adjacent lengths of pipe are butt-welded to one another, a threaded box connector coupled to a first end of the first section of pipe and a threaded pin connector coupled to a second end of the first section of pipe, the threaded pin connector having an exterior sealing surface and an end surface on the pin connector that is adapted to define a portion of an external grooved circumferential weld joint between the pin connector and a mating box connector on a second section of pipe comprised of at least one length of pipe when the pin connector and the mating box connector on the second section of pipe are threadingly coupled to one another, the mating box connector further comprising an internal sealing surface that is adapted to sealingly engage the exterior sealing surface on the pin connector when the pin connector and the mating box connector are threadingly coupled to one another.

In one illustrative embodiment, the method comprises forming a pipeline, an end of the pipeline having a threaded connector, providing a pipe section comprised of at least one length of pipe, the pipe section having threaded connectors on each end of the pipe section, threadingly coupling one of the threaded connectors on the pipe section to the threaded connector on the end of the pipeline and welding the threaded connector on the pipe section to the threaded connector on the end of the previously formed pipeline along an exterior circumferential weld joint. In further embodiments, the step of threadingly coupling one of the connectors on the pipe section to the threaded connector on the end of the pipeline establishes a sealing interface by providing an interference fit between a sealing surface on the connector on the pipe section and a sealing surface on the connector on the end of the pipeline.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A device, comprising:
a first section of pipe comprised of at least one length of pipe;
a threaded pin connector coupled to said first section of pipe;
a second section of pipe comprised of at least one length of pipe; and
a threaded box connector coupled to said second section of pipe, said box and pin connectors being threadingly coupled to one another and welded to one another along an exterior grooved circumferential weld joint.

2. The device of claim 1, wherein said first section of pipe is comprised of a plurality of lengths of pipe wherein adjacent lengths of pipe are butt-welded to one another.

3. The device of claim 1, wherein said second section of pipe is comprised of a plurality of lengths of pipe wherein adjacent lengths of pipe are butt-welded to one another.

4. The device of claim 1, wherein said threaded box and pin connectors comprise wedged dovetail threads with a continuously varying flank-to-flank width.

5. The device of claim 1, wherein said threaded pin connector is butt-welded to said first section of pipe.

6. The device of claim 1, wherein said threaded box connector is butt-welded to said second section of pipe.

7. The device of claim 1, further comprising a sealing interface between an exterior sealing surface of said pin connector and an interior sealing surface of said box connector.

8. The device of claim 7, wherein said sealing interface is established by providing an interference fit between said exterior sealing surface of said pin connector and said interior sealing surface of said box connector.

9. The device of claim 1, wherein said grooved circumferential weld joint extends around the entire circumference of said pin and box connectors.

10. The device of claim 1, wherein said grooved circumferential weld joint has a depth that is less than a thickness of said at least one length of pipe of said first section of pipe.

11. The device of claim 1, wherein said grooved circumferential weld joint has a depth that is approximately 20-30 percent of a thickness of said at least one length of pipe of said first section of pipe.

12. The device of claim 1, wherein said grooved circumferential weld joint is a J-groove weld joint.

13. The device of claim 1, wherein said grooved circumferential weld joint is defined by an end surface of said box connector and a surface of said pin connector.

14. The device of claim 1, wherein said grooved circumferential weld joint is defined by an end surface of said box connector and a side surface of a shoulder on said pin connector.

15. The device of claim 1, wherein said grooved circumferential weld joint is defined by an end surface of said box connector and a side surface of a shoulder on said pin connector, wherein a diameter of an outer surface of said shoulder and a diameter of an outer surface of said box connector at said grooved circumferential weld joint are approximately the same.

16. The device of claim 1, wherein said grooved circumferential weld joint is filled with a single weld pass.

17. The device of claim 1, wherein said grooved circumferential weld joint is filled using a submerged arc welding process.

18. The device of claim 1, further comprising a recessed attachment area on each of said pin and box connectors.

19. A device, comprising:
a first section of pipe comprised of a plurality of lengths of pipe wherein adjacent lengths of pipe are butt-welded to one another;
a threaded pin connector coupled to said first section of pipe;
a second section of pipe comprised of a plurality of lengths of pipe wherein adjacent lengths of pipe are butt-welded to one another; and
a threaded box connector coupled to said second section of pipe, said box and pin connectors being threadingly coupled to one another and welded to one another along an exterior grooved circumferential weld joint, wherein a sealing interface exists between an exterior sealing surface of said pin connector and an interior sealing surface of said box connector.

20. The device of claim 19, wherein said threaded box and pin connectors comprise wedged dovetail threads with a continuously varying flank-to-flank width.

21. The device of claim 19, wherein said threaded pin connector is butt-welded to said first section of pipe.

22. The device of claim 19, wherein said threaded box connector is butt-welded to said second section of pipe.

23. The device of claim 19, wherein said sealing interface is established by providing an interference fit between said exterior sealing surface of said pin connector and said interior sealing surface of said box connector.

24. The device of claim 19, wherein said grooved circumferential weld joint extends around the entire circumference of said pin and box connectors.

25. The device of claim 19, wherein said grooved circumferential weld joint has a depth that is less than a thickness of one of said plurality of lengths of pipe of said first section of pipe.

26. The device of claim 19, wherein said grooved circumferential weld joint has a depth that is approximately 20-30 percent of a thickness of one of said at plurality of lengths of pipe of said first section of pipe.

27. The device of claim 19, wherein said grooved circumferential weld joint is a J-groove weld joint.

28. The device of claim 19, wherein said grooved circumferential weld joint is defined by an end surface of said box connector and a surface of said pin connector.

29. The device of claim 19, wherein said grooved circumferential weld joint is defined by an end surface of said box connector and a side surface of a shoulder on said pin connector.

30. The device of claim 19, wherein said grooved circumferential weld joint is defined by an end surface of said box connector and a side surface of a shoulder on said pin connector, wherein a diameter of an outer surface of said shoulder and a diameter of an outer surface of said box connector at said grooved circumferential weld joint are approximately the same.

31. The device of claim 19, wherein said grooved circumferential weld joint is filled with a single weld pass.

32. The device of claim 19, wherein said grooved circumferential weld joint is filled using a submerged arc welding process.

33. The device of claim 19, further comprising a recessed attachment area on each of said pin and box connectors.

34. A device, comprising:
a first section of pipe comprised of at least one length of pipe;
a threaded box connector coupled to a first end of said first section of pipe; and
a threaded pin connector coupled to a second end of said first section of pipe, wherein an end surface on said pin connector is adapted to define a portion of an external grooved circumferential weld joint between said pin connector and a mating box connector on a second section of pipe comprised of at least one length of pipe when said pin connector and said mating box connector on said second section of pipe are threadingly coupled to one another.

35. The device of claim 34, further comprising an exterior sealing surface on said pin connector that is adapted to engage an interior sealing surface on said mating box connector when said pin connector and said mating box connector are threadingly coupled to one another.

36. The device of claim 35, wherein a sealing interface is established by providing an interference fit between said exterior sealing surface on said pin connector and said interior sealing surface on said mating box connector on said second section of pipe.

37. The device of claim 34, wherein said first section of pipe is comprised of a plurality of lengths of pipe wherein adjacent lengths of pipe are butt-welded to one another.

38. The device of claim 34, wherein said second section of pipe is comprised of a plurality of lengths of pipe wherein adjacent lengths of pipe are butt-welded to one another.

39. The device of claim 34, wherein said threaded box and pin connectors coupled to said first section of pipe comprise wedged dovetail threads with a continuously varying flank-to-flank width.

40. The device of claim 34, wherein said threaded pin connector is butt-welded to said first section of pipe.

41. The device of claim 34, wherein said threaded box connector is butt-welded to said first section of pipe.

42. The device of claim 34, wherein said grooved circumferential weld joint extends around the entire circumference of said pin connector and said mated box connector on said second section of pipe.

43. The device of claim 34, wherein said grooved circumferential weld joint has a depth that is less than a thickness of said at least one length of pipe of said first section of pipe.

44. The device of claim 34, wherein said grooved circumferential weld joint has a depth that is approximately 20-30 percent of a thickness of said at least one length of pipe of said first section of pipe.

45. The device of claim 34, wherein said grooved circumferential weld joint is a J-groove weld joint.

46. The device of claim 34, wherein said grooved circumferential weld joint is adapted to be further defined by a side surface of a shoulder on said mating box connector.

47. The device of claim 34, wherein said circumferential weld joint is adapted to be filled with a single weld pass.

48. The device of claim 34, wherein said grooved circumferential weld joint is adapted to be filled using a submerged arc welding process.

49. The device of claim 34, further comprising a recessed attachment area on each of said pin and box connectors.

50. A device, comprising:
a first section of pipe comprised of a plurality of lengths of pipe wherein adjacent lengths of pipe are butt-welded to one another;
a threaded box connector coupled to a first end of said first section of pipe; and
a threaded pin connector coupled to a second end of said first section of pipe, said threaded pin connector having an exterior sealing surface and an end surface on said pin connector that is adapted to define a portion of an external grooved circumferential weld joint between said pin connector and a mating box connector on a second section of pipe comprised of at least one length of pipe when said pin connector and said mating box connector on said second section of pipe are threadingly coupled to one another, said mating box connector further comprising an internal sealing surface that is adapted to sealingly engage said exterior sealing surface on said pin connector when said pin connector and said mating box connector are threadingly coupled to one another.

51. The device of claim 50, wherein a sealing interface is established by providing an interference fit between said exterior sealing surface of said pin connector and said interior sealing surface of said mating box connector on said second section of pipe.

52. The device of claim 50, wherein said second section of pipe is comprised of a plurality of lengths of pipe wherein adjacent lengths of pipe are butt-welded to one another.

53. The device of claim 50, wherein said threaded box and pin connectors on said first section of pipe comprise wedged dovetail threads with a continuously varying flank-to-flank width.

54. The device of claim 50, wherein said threaded pin connector is butt-welded to said first section of pipe.

55. The device of claim 50, wherein said threaded box connector is butt-welded to said first section of pipe.

56. The device of claim 50, wherein said grooved circumferential weld joint extends around the entire circumference of said pin connector and said mated box connector on said second section of pipe.

57. The device of claim 50, wherein said grooved circumferential weld joint has a depth that is less than a thickness of one of said plurality of lengths of pipe of said first section of pipe.

58. The device of claim 50, wherein said grooved circumferential weld joint has a depth that is approximately 20-30 percent of a thickness of one of said plurality of lengths of pipe of said first section of pipe.

59. The device of claim 50, wherein said circumferential weld joint is a J-groove weld joint.

60. The device of claim 50, wherein said grooved circumferential weld joint is adapted to be further defined by a side surface of a shoulder on said mating box connector.

61. The device of claim 50, wherein said grooved circumferential weld joint is adapted to be filled with a single weld pass.

62. The device of claim 50, wherein said grooved circumferential weld joint is adapted to be filled using a submerged arc welding process.

63. The device of claim 50, further comprising a recessed attachment area on each of said pin and box connectors.

64. A method, comprising:
forming a pipeline, an end of said pipeline having a threaded connector;
providing a pipe section comprised of at least one length of pipe, said pipe section having threaded connectors on each end of said pipe section;
threadingly coupling one of said threaded connectors on said pipe section to said threaded connector on said end of said pipeline; and
welding said threaded connector on said pipe section to said threaded connector on said end of said pipeline along an exterior circumferential weld joint.

65. The method of claim 64, wherein said step of threadingly coupling one of said connectors on said pipe section to said threaded connector on said end of said pipeline establishes a sealing interface by providing an interference fit between a sealing surface on said connector on said pipe section and a sealing surface on said connector on said end of said pipeline.

66. The method of claim 64, wherein said pipeline is at least one of a subsea and a surface pipeline.

67. The method of claim 64, wherein said pipeline is a sub-surface pipeline and said pipeline is formed using at least one of an S-lay technique and a J-lay technique.

68. The method of claim 64, wherein said step of threadingly coupling one of said threaded connectors on said pipe section to said threaded connector on said end of said pipeline is accomplished by rotating said pipe section relative to said end of said pipeline.

69. The method of claim 68, wherein said pipe section is rotated by actuating at least one of a top drive and a power tong.

70. The method of claim 64, wherein said step of welding is accomplished by performing a single weld pass to fill said circumferential weld joint.

71. The method of claim 64, wherein said pipe section has a threaded pin connector and said threaded connector on said end of said pipeline is a threaded box connector, said threaded pin connector on said pipe section being adapted to be threadingly coupled to said threaded box connector on said end of said pipeline.

72. The method of claim 64, wherein said pipe section has a threaded box connector and said threaded connector on said end of said pipeline is a threaded pin connector, said threaded box connector on said pipe section being adapted to be threadingly coupled to said threaded pin connector on said end of said pipeline.

73. The method of claim 64, wherein said pipe section is comprised of a plurality of lengths of pipe wherein adjacent lengths of pipe are butt-welded to one another.

74. The method of claim 64, wherein said connectors on said pipe section and on said end of said pipeline comprise wedged dovetail threads with a continuously varying flank-to-flank width.

75. The method of claim 64, wherein said threaded connectors are butt-welded to said pipe section.

76. The method of claim 64, wherein said step of welding creates a circumferential weld joint that extends around the entire circumference of said threaded connector on said pipe section and said threaded connector on said end of said pipeline.

77. The method of claim 76, wherein said circumferential weld joint is a J-groove weld joint.

78. The method of claim 64, wherein said circumferential weld joint is a grooved circumferential weld joint.

79. The method of claim 76, wherein said step of welding is a single weld pass that substantially fills said circumferential weld joint.

80. The method of claim 50, wherein said circumferential weld joint has a depth that is less than a thickness of said at least one length of pipe of said pipe section.

81. The method of claim 50, wherein said circumferential weld joint has a depth that is approximately 20-30 percent of a thickness of said at least one length of pipe of said pipe section.
